(19) United States
(12) Patent Application Publication
(10) Pub. No.: US 2025/0140055 A1
(43) Pub. Date: May 1, 2025

(54) DISPLAYING A DIGITAL ELEMENT ON A DISPLAY SURFACE ASSOCIATED WITH A MECHANICAL REEL OF AN ELECTRONIC GAMING MACHINE

(71) Applicant: IGT, Las Vegas, NV (US)

(72) Inventors: David FROY, Lakeville-Westmorland (CA); Sven AURICH, Schwanberg (AT); Michael RUSS, Graz (AT); David SMALL, Moncton (CA); Soheil LATIFI, Brampton (CA); Stefan KEILWERT, St. Josef (AT)

(73) Assignee: IGT, Las Vegas, NV (US)

(21) Appl. No.: 18/496,502

(22) Filed: Oct. 27, 2023

(51) Int. Cl. G07F 17/32; A63F 13/28; A63F 13/57; G06F 3/04817

(52) U.S. Cl. CPC G07F 17/3213; A63F 13/28; A63F 13/57; G06F 3/04817; G07F 17/3223; A63F 2300/30

(57) ABSTRACT

An electronic gaming machine (“EGM”) can include a set of mechanical reels; a display surface; and a projector. The projector can be configured to project a digital element on the display surface. The display surface can be located between the projector and the set of mechanical reels.

### BACKGROUND

Embodiments described herein relate to electronic gaming machines (“EGMs”). EGMs can include one or more games (e.g., wagering games) stored therein that can be played by a player. The EGM can provide a prize to the player based on a wager and an outcome of a wagering game. An example of a wagering game includes a slot game in which, in response to receiving a wager from the player, one or more rows of symbols are revealed. In some examples, the symbols can be affixed to one or more reel strips that form a set of mechanical reels. Each reel strip can separately spin to produce the one or more rows of symbols. A prize can be provided to the player based on the one or more rows of physical symbols including one or more winning combinations of symbols. In other examples, a set of virtual symbols can be displayed on a display device to form a virtual set of reels. A prize can be provided to the player based on the one or more rows of virtual symbols including one or more winning combinations of virtual symbols.

### SUMMARY

According to some embodiments, an electronic gaming machine (“EGM”) is provided. The EGM includes a set of mechanical reels, a display surface, and a projector. The projector is configured to project a digital element on the display surface. The display surface is located between the projector and the set of mechanical reels.

According to other embodiments, a method of operating an electronic gaming machine (“EGM”) is provided. The method includes spinning a set of mechanical reels as part of a wagering game. The method further includes displaying, using a projector, a digital element on a display surface between the projector and the set of mechanical reels.

According to other embodiments, an electronic gaming machine (“EGM”) is provided. The EGM includes processing circuitry and memory. The memory is communicatively coupled to the processing circuitry and includes instructions stored therein that are executable by the processing circuitry to cause the EGM to perform operations. The operations include determining physical content on a set of mechanical reels associated with a wagering game. The operations further include displaying, using a projector, digital content on a display surface between the projector and the set of mechanical reels, the digital content based on the physical content.

According to other embodiments, a method, an EGM, a system, or non-transitory computer-readable medium are provided for performing the above embodiments.

### BRIEF DESCRIPTION OF THE DRAWINGS

FIG. 1 is a schematic block diagram illustrating an example of a network configuration for a plurality of gaming devices according to some embodiments;

FIGS. 2A-E are diagrams illustrating examples of gaming devices according to some embodiments;

FIGS. 3-4 are schematic diagrams illustrating examples of a gaming device with a mechanical reel that includes a display surface for displaying a digital element according to some embodiments;

FIGS. 5A-D are schematic diagrams illustrating examples of the display surface of FIGS. 3-4 relative to a mechanical reel according to some embodiments; and

FIGS. 6-8 are flow charts illustrating examples of operations performed by an EGM according to some embodiments.

### DETAILED DESCRIPTION

A gaming device such as an electronic gaming machine (“EGM”) can include reel games (or slot games), and the EGM can be referred to as a slot machine. In some examples, a gaming device can include a mechanical reel set (including multiple physical reel strips) and a light source that acts as a backlight by shining a light through the physical reel towards a user. Each physical reel strip can include a transparent surface with a plurality of symbols attached (e.g., printed) thereon. The light can pass through the physical reel strip and illuminate a portion of the symbols that are on a portion of the physical reel strip. In other examples, a gaming device can include a digital display that is configured to display a virtual reel set (including multiple virtual reel strips). The digital display can be configured to display an animation that gives the impression that the virtual reel set is spinning similar to gaming devices with a mechanical reel set.

A virtual-reel slot machine can provide several improvements over a mechanical-reel slot machine. In some examples, a virtual-reel slot machine can provide a slot game with additional features that are difficult and/or impossible for a mechanical-reel slot machine. These additional features can include the ability to provide a virtual bonus game in response to a specific trigger condition such as an outcome of the slot game including a specific combination of virtual symbols. A virtual-reel slot machine can also “lock” a virtual symbol in place on a virtual reel (such that the virtual symbol being displayed at a specific position remains unchanged) while “spinning” the other virtual symbols on the virtual reel (such that the other virtual symbols change). A virtual-reel slot machine can also have the ability to display additional information compared to a mechanical-reel slot machine including: an indication of pay-lines; an indication of a wager amount, an indication of a winning combination of symbols. A virtual-reel slot machine can also adjust how information and/or symbols are displayed on the digital display such as changing a font, size, or color of the virtual symbols.

In additional or alternative examples, a slot game provided by a virtual-reel slot machine can be electronically swapped out for a different slot game. In additional or alternative examples, a virtual-reel slot machine can be capable of providing one of multiple wagering games that can be selected by a user. By contrast, a mechanical-reel slot machine may have a single available game and the entire mechanical-reel slot machine may have to be replaced by an operator in order to provide a different wagering game. Despite these (and other) potential advantages of a virtual-reel slot machine, some users enjoy (and in some instances prefer) playing on a mechanical-reel slot machine.

Various embodiments herein describe an EGM that includes a mechanical reel and a display surface for displaying virtual elements. In some embodiments, the EGM can be configured to display the virtual elements to provide additional features (e.g., features present in virtual-reel slot machines) while providing a wagering game using a mechanical reel. In some examples, the digital elements can include virtual symbols or animations and the digital elements can be displayed on the display surface such that they appear to be on the mechanical reel (in addition or instead of physical symbols on the mechanical reel).

In additional or alternative embodiments, the EGM includes a mechanical reel, a display surface, and a projector configured to project a digital element on the display surface. In some examples, the display surface is located between the projector and the set of mechanical reels. In additional or alternative examples, the display surface is located between the set of mechanical reels and a user playing the EGM. In additional or alternative embodiments, the display surface can include a transparent portion such that a portion of the mechanical reel is visible to a user of the EGM. The display surface can also include a reflective portion such that a digital element (projected by the projector onto the display surface) is visible to the user. In some examples, a transparent reflective film, which reflects light that is directed towards it can be used as the display surface. The film can be installed over a traditional plastic surrounding a paper or plastic insert for the mechanical reels. The display surface can be transparent until impacted by light from the projector. In additional or alternative examples, the display surface includes a liquid crystal display and its transparency varies in response to an electrical charge being applied to the liquid crystal display.

In some examples, users of traditional mechanical reel games like the simplicity and feel of the mechanical reel spinning. However, the mechanical-reel slot machines can be seen as static (other than potentially flashing of a back light). In some embodiments, it is advantageous to enhance the user experience with rich animations and dynamic graphics being projected on top of the reels. In additional or alternative embodiments, it is advantageous to allow mechanical-reel slot machines to provide more diverse wagering games by adding digital features. In additional or alternative embodiments, it is advantageous to allow mechanical-reel slot machines to include more than one wagering game by enabling virtual elements to modify the underlying mechanical-reel game.

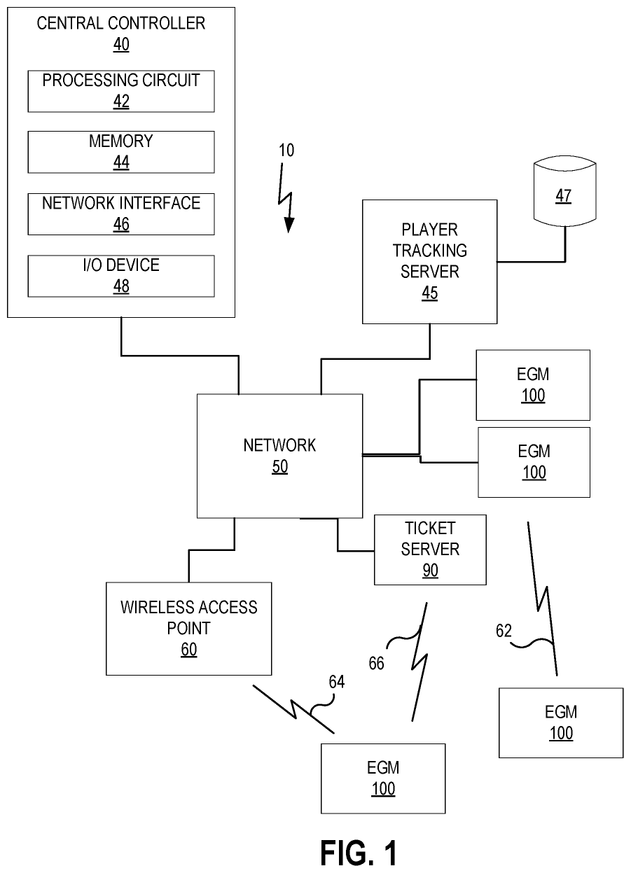

Before describing these and other embodiments in detail, reference is made to FIG. 1, which illustrates a gaming system 10 including a plurality of gaming devices 100. As discussed above, the gaming devices 100 may be one type of a variety of different types of gaming devices, such as electronic gaming machines (EGMs), mobile devices, or other devices, for example. The gaming system 10 may be located, for example, on the premises of a gaming establishment, such as a casino. The gaming devices 100, which are typically situated on a casino floor, may be in communication with each other and/or at least one central controller 40 through a data communication network 50 that may include a remote communication link. The central controller 40 can include processing circuit 42, memory 44, network interface 46, and an input/output (“I/O”) device 48. In some examples, the memory 44 includes instructions executable by processing circuit 42 for causing the central controller 40 to perform operations. The operations can include communicating with the data communication network 50 via the network interface 46 and/or communicating with a user/operator via the I/O device 48.

The data communication network 50 may be a private data communication network that is operated, for example, by the gaming facility that operates the gaming devices 100. Communications over the data communication network 50 may be encrypted for security. The central controller 40 may be any suitable server or computing device which includes at least one processor circuit and at least one memory or storage device. Each gaming device 100 may include a processor circuit that transmits and receives events, messages, commands or any other suitable data or signal between the gaming device 100 and the central controller 40. The gaming device processor circuit is operable to execute such communicated events, messages or commands in conjunction with the operation of the gaming device 100. Moreover, the processor circuit of the central controller 40 is configured to transmit and receive events, messages, commands or any other suitable data or signal between the central controller 40 and each of the individual gaming devices 100. In some embodiments, one or more of the functions of the central controller 40 may be performed by one or more gaming device processor circuits. Moreover, in some embodiments, one or more of the functions of one or more gaming device processor circuits as disclosed herein may be performed by the central controller 40.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 through the data communication network 50. Each ticket server 90 may include a processor circuit that transmits and receives events, messages, commands or any other suitable data or signal between the ticket server 90 and the central controller 40. The ticket server 90 processor circuit may be operable to execute such communicated events, messages or commands in conjunction with the operation of the ticket server 90. Moreover, in some embodiments, one or more of the functions of one or more ticket server 90 processor circuits as disclosed herein may be performed by the central controller 40.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, an NFC link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. In still further embodiments, the gaming devices 100 may communicate simultaneously with both the ticket server 90 over the wireless interface 66 and the wireless access point 60 over the wireless interface 64. Some embodiments provide that gaming devices 100 may communicate with other gaming devices over a wireless interface 64. In these embodiments, wireless interface 62, wireless interface 64 and wireless interface 66 may use different communication protocols and/or different communication resources, such as different frequencies, time slots, spreading codes, etc.

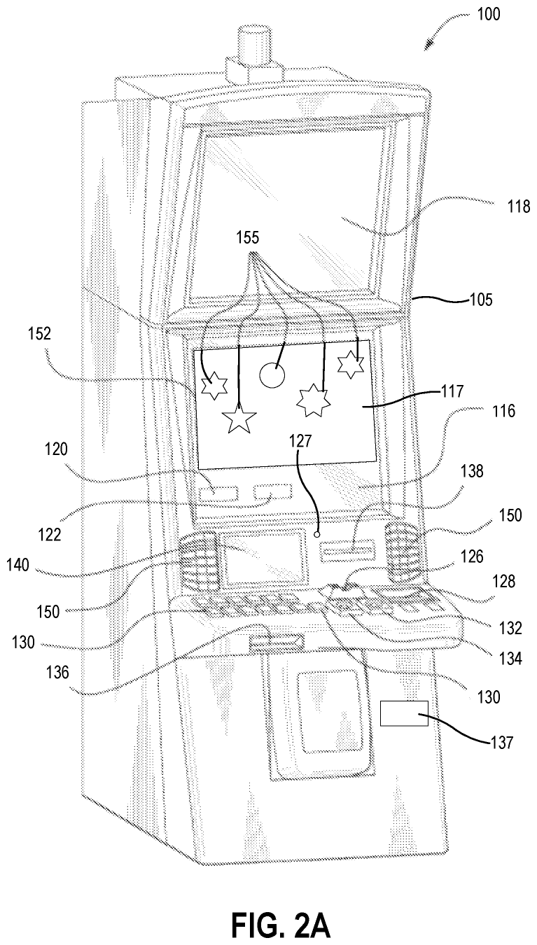

Embodiments herein may include different types of gaming devices. Various embodiments are illustrated in FIGS. 2A-2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A-C are provided as examples for illustrative purposes only. It will be appreciated that gaming devices may come in many different shapes, sizes, layouts, form factors, and configurations, and with varying numbers and types of input and output devices, and that embodiments of the inventive concepts are not limited to the particular gaming device structures described herein.

Gaming devices 100 typically include a number of standard features, many of which are illustrated in FIGS. 2A-B. For example, referring to FIG. 2A, a gaming device 100 may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processor circuit 12 or directly from a memory device 14 and displays the video data on the display screen. The credit display 120 and the bet display 122 are typically implemented as simple LCD or LED displays that display a number of credits available for wagering and a number of credits being wagered on a particular game. Accordingly, the credit display 120 and the bet display 122 may be driven directly by the processor circuit 12. In some embodiments however, the credit display 120 and/or the bet display 122 may be driven by the video controller 30. The gaming device 100 may also include a player tracking unit 24 for managing communications and functionality between the processor circuit 12 and certain peripherals and components. Player tracking units 24 may be standardized across machine types to operate interchangeably across a manufacturer's lineup.

Referring again to FIG. 2A, the display devices 116, 118, 140 may include, without limitation: a cathode ray tube, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket printer 136, a bill/ticket acceptor/dispenser 128, that allows the player to deposit and/or receive tickets and/or currency into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processor circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processor circuit 12 that controls operations of the gaming device 100. Although illustrated as a single processor circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processor circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processor circuit 12. It will be appreciated that the components may be connected to the processor circuit 12 through a system bus 151, a communication bus and controller, such as a USB controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processor circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, DVD or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or near field communications (NFC) that enable the gaming device 100 to communicate, for example, with a mobile communication device operated by a player.

The gaming device 100 may include one or more internal or external communication ports that enable the processor circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb drives, ticket readers, touch screens, trackballs, touchpads, wheels, and wireless communication devices. In some embodiments, internal or external peripheral devices may communicate with the processor circuit through a universal serial bus (USB) hub (not shown) connected to the processor circuit 12.

In some embodiments, the gaming device 100 may include a sensor, such as a camera 127, in communication with the processor circuit 12 (and possibly controlled by the processor circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processor circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

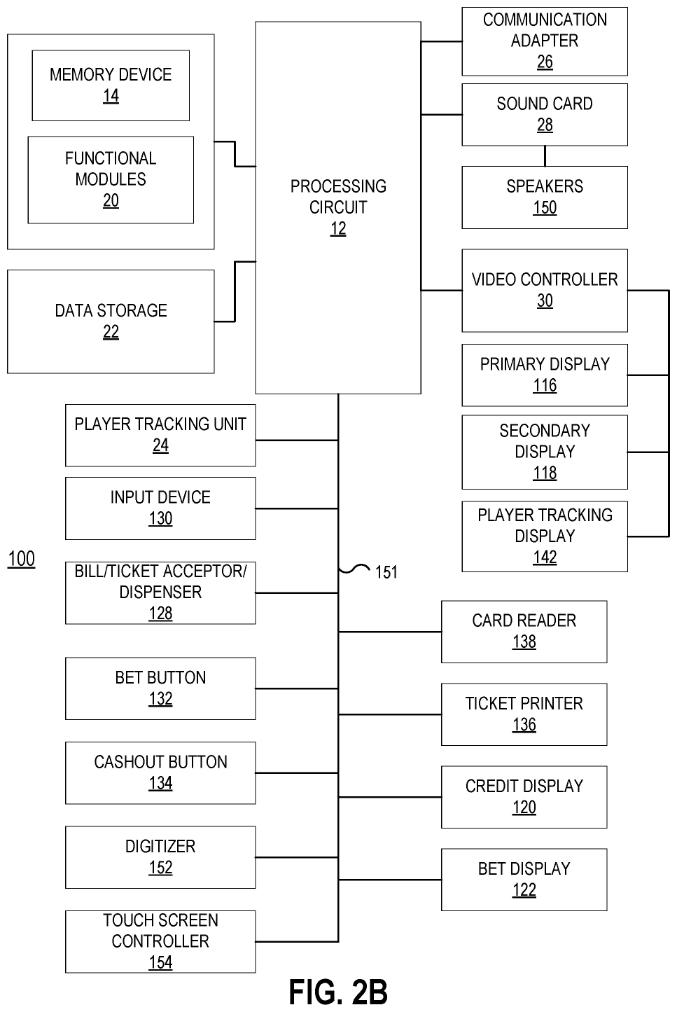

For example, referring to FIG. 2D, a gaming device 100′ may be implemented as a handheld device including a compact housing 105 on which is mounted a touchscreen display device 116 including a digitizer 152. As described in greater detail with respect to FIG. 3 below, one or more input devices 130 may be included for providing functionality of for embodiments described herein. A camera 127 may be provided in a front face of the housing 105. The housing 105 may include one or more speakers 150. In the gaming device 100′, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100′ may omit certain features, such as a bill acceptor, a ticket generator, a coin acceptor or dispenser, a card reader, secondary displays, a bet display, a credit display, etc. Credits can be deposited in or transferred from the gaming device 100′ electronically.

FIG. 2E illustrates a standalone gaming device 100″, i.e., an EGM in this example, having a different form factor from the gaming device 100 illustrated in FIG. 2A. In particular, the gaming device 100″ is characterized by having a large, high aspect ratio, curved primary display device 116′ provided in the housing 105, with no secondary display device. The primary display device 116′ may include a digitizer 152 to allow touchscreen interaction with the primary display device 116′. The gaming device 100″ may further include a player tracking display 142, an input device 130, a bill/ticket acceptor 128, a card reader 138, and a bill/ticket dispenser 136. The gaming device 100″ may further include one or more cameras 127 to enable facial recognition and/or motion tracking.

Although illustrated as certain gaming devices, such as electronic gaming machines (EGMs) and mobile devices, similar functions and/or operations as described herein may include wagering stations that may include electronic game tables, conventional game tables including those involving cards, dice and/or roulette, and/or other wagering stations such as sports book stations, video poker games, skill-based games, virtual casino-style table games, or other casino or non-casino style games. Further, gaming devices according to embodiments herein may be implemented using other computing devices and mobile devices, such as smart phones, tablets, and/or personal computers, among others.

Various embodiments herein describe an EGM that includes a mechanical reel and a display surface for displaying virtual elements. In some embodiments, the display surface includes a reflective film that is transparent. The reflective film can be flexible and overlayed over a set of mechanical reels. In additional or alternative embodiments, a projected light from either a pico projector or a laser-based projector is transmitted onto the surface of the reflective film and acts as a display. In some examples, the projector is not in the layer between the mechanical reel and the reflective film. Instead, for example, the projector can be positioned below the reels, such as underneath a button panel of the EGM. If activated, the projector can project content so that it appears to be on the mechanical reel. In some examples, the content includes animations that are overlayed overtop of the physical images on the physical reel strip. In additional or alternative examples, the mechanical reels can include blank spaces (or can be completely blank) and virtual symbols and/or animations can be overlayed on the blank spaces.

In additional or alternative embodiments, with the use of reflective film, when light is projected upon a surface, the surface will reflect back the light projected upon it. When no light source is applied, the film can be transparent and the images below the surface of the film can be visible. In additional or alternative embodiments, the reflective film can use a type of liquid crystal to make the transparent film opaque and block any images behind the transparent film from appearing. In additional or alternative embodiments, an EGM can hide (e.g., make transparent) the display surface by turning off the projector or directing the light from the projector to be displayed on a different surface (not the display surface). In additional or alternative embodiments, the EGM can hide the display surface by adjusting the display surface itself (e.g., a transparency of the display surface may be variable in response to applying an electrical charge to the display surface).

FIG. 3 illustrates an example of an EGM 300 including a mechanical reel 310, a display surface 320, a projector 330, front screen 340, and button panel 350. The display surface 320 is physically separate from the mechanical reel 310 and positioned between the mechanical reel 310 and the projector 330 (and between the mechanical reel 310 and the front screen 340).

The mechanical reel 310 can be one mechanical reel of a set of mechanical reels that are each capable of spinning individually. In some examples, the mechanical reel 310 includes a series of physical symbols that can be used as part of a wagering game (e.g., a slot game). The display surface 320 may be transparent such that a user of the EGM may look through the front screen 340 and view the mechanical reel 310 through the display surface 320. The projector 330 can project a virtual element (e.g., a virtual symbol) on the display surface 320, which can overlap and/or block a portion of the mechanical reel 310 from being viewed by the user from the perspective of the front screen 340.

In additional or alternative examples, the mechanical reel 310 includes a series of blank spaces. The projector 330 can project a virtual element (e.g., a virtual symbol) on the display surface 320 such that the virtual element appears to be positioned at one of the blank spaces on the mechanical reel 310 (from the perspective of a user of the EGM).

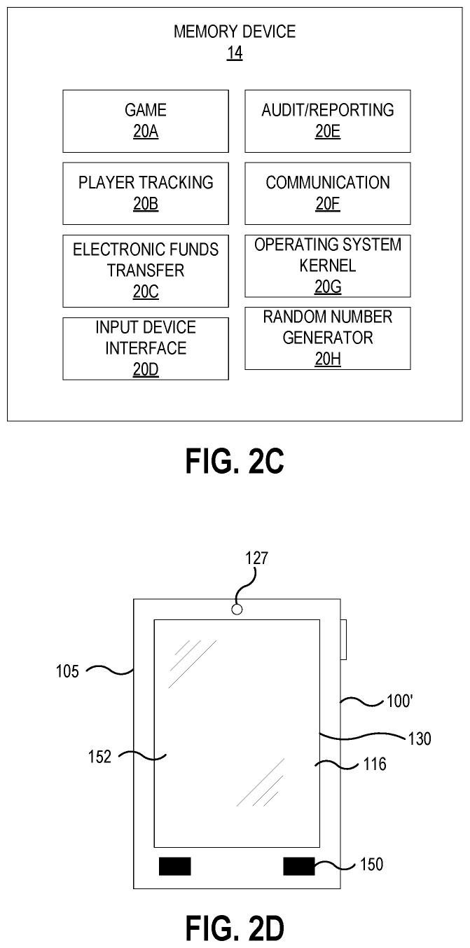

FIG. 4 illustrates an example of an EGM 400 that also includes the mechanical reel 310, the projector 330, the front screen 340, and the button panel 350. EGM 400 further includes (rather than display surface 320) a reflective film 420 applied to a surface of the mechanical reel 310. Similar to the display surface 320, the reflective film 420 can be transparent such that a user of the EGM may look through the front screen 340 and view the mechanical reel 310 through the reflective film 420. Furthermore, the projector 330 can project a virtual element (e.g., a virtual symbol) on the reflective film 420, which can overlap and/or block a portion of the mechanical reel 310 from being viewed by the user from the perspective of the front screen 340. Although the terms display surface and reflective film are used separately to distinguish the implementation in FIG. 3 from the implementation in FIG. 4, the term display surface is sometimes used herein to refer to either of these implementations or any other suitable implementation.

In some examples, the reflective film 420 allows light that is front projected upon a surface of the reflective film 420 to be reflected. The light can be visible to a user standing in front of the EGM 400. Accordingly, images and animations projected upon the reflective film 420 can be visible to users of the EGM 400. When the light source (e.g., the projector) is turned off, the film can be transparent and any objects behind the reflective film can be visible to the user. In additional or alternative examples, the reflective film is active in that the film includes liquid crystals that can be controlled by a controller and turned/twisted to prevent light from behind the reflective film 420 from passing through (e.g., making the reflective film opaque).

The projector 330 in FIGS. 3-4 can be a pico projector or a laser projector positioned within the EGM 300, 400 and can be configured to project light upon the display surface 320 (or reflective film 420). In some examples, using a laser projector allows the EGM to only apply light to areas which are to display an image, which can cause parts of the display surface 320 (or reflective film 420) to remain transparent.

In some embodiments, a mechanical reel includes a motor to move the reels, a cage in which to hold the paper or plastic based reel and a reflective surface film cover over the paper reels. In the case of the active reflective film, a power source as well as a controller is embedded within the reel assembly which allows for the control of the active reflective film.

In additional or alternative embodiments, during game play, the mechanical reels come to a stop and a line win is awarded. The game logic box can send a video signal to the projector to display an animation over top of the mechanical reels to indicate where the win was awarded. Animations for the symbol may also be played over top of the symbols. Other images may be projected upon the reels such as progressive pots, anticipation animations, or bonus trigger symbols. As the reels are spun, a light detecting sensor can be used to detect where the reels are physically located and can be used to help synchronize the mechanical reels and virtual reels. In some examples, a reflective gap on the side of the mechanical reel or light blocking strips can be used to help facilitate the detection of the rotation of the reels. In additional or alternative examples, control feedback of the stepper motors can be used to determine where the reels are physically located.

In additional or alternative embodiments, the projector can be turned off to allow for the mechanical reels to be displayed normally. During game play, different events can turn on the projector to display graphics on the mechanical reels. In some examples, various events can be used to trigger the projector to display images such as attract mode, linked progressive wins, and bonus pots.

In additional or alternative embodiments, transparent film can be used that supports back lighting on the front glass of the EGM. This can also be used by a projector to display images over the mechanical reels or act as a second screen where other bonuses such as pick-a-prize and other games of choice can be played. When no projector is displaying on the front glass, the reels underneath are visible to the user.

Although the reflective film 420 is illustrated as being directly overlaid on the mechanical reel 310 other implementations are possible. In some examples, one or more layers may be between the reflective film 420 and the mechanical reel 310. In additional or alternative examples, a reflective film may be applied to a surface adjacent to the mechanical reel (e.g., a structure holding the mechanical reel). Although the reflective film 420 is illustrates as fully encompassing the mechanical reel 310, a reflective film may only cover a portion of the mechanical reel 310. In some examples, the reflective film 420 spins (or otherwise moves) with the mechanical reel 310. In other examples, the reflective film 420 remains stationary while the mechanical reel 310 spins.

The front screen 340 is illustrated in FIGS. 3-4 to provide an example of a line of sight available to a user of the EGM. The front screen 340 may be a display device, a transparent surface, or an opening through which the user can view the mechanical reel 310 through the display surface 320 (and/or digital elements on the display surface 320).

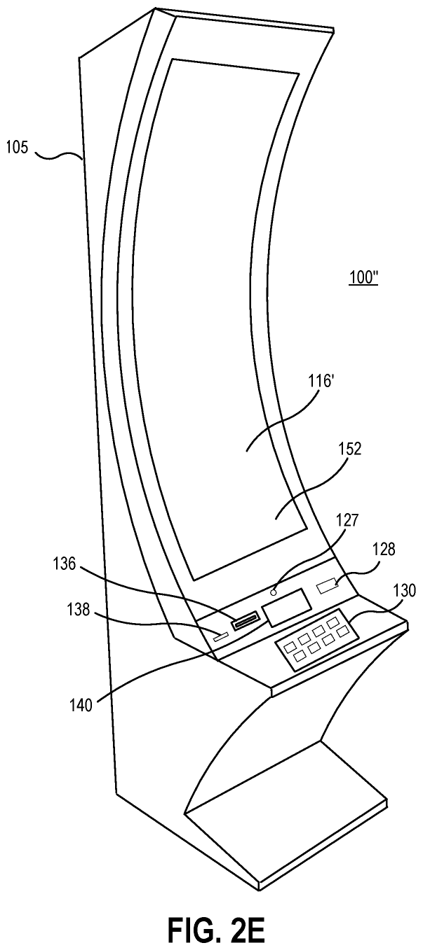

FIGS. 5A-D illustrate examples of a perspective of the display surface 320 (which may also be a reflective film 420) overlaying the mechanical reel 310 from the perspective of a user. FIG. 5A illustrates an example in which the display surface 320 is transparent such that the mechanical reel 310 is visible through the display surface 320. In this example, the portion of the mechanical reel 310 that is facing forward (e.g., the portion selected as part of the game) includes three symbol positions 312 that are each populated with a symbol printed on the mechanical reel 310. In other examples, one or more of the symbol positions 312 may be blank.

FIG. 5B illustrates an example in which the display surface 320 is opaque such that the mechanical reel 310 is not visible through the display surface 320. In some examples, the transparency of the display surface 320 may be varied in response to an electrical charge being applied to the display surface 320. In additional or alternative examples, the transparency of the display surface 320 may be varied in response to light projected by a projector reflecting off a surface of the display surface 320.

FIGS. 5C-D illustrate examples in which a digital element 522 is projected onto the display surface 320. In FIG. 5C, the digital element 522 is projected such that the digital element 522 is visible rather than the mechanical reel 310. In FIG. 5D, the digital element 522 is projected such that it appears to be at one of the symbol positions 312 on the mechanical reel 310 while other symbols at other symbol positions 312 are visible through the display surface 320. In some examples, the digital element is an alternative symbol. In additional or alternative examples, the digital element includes an animation or image based on the symbol that is at the corresponding symbol position 312 on the mechanical reel 310.

Embodiments associated with the type of digital elements that can be combined with a mechanical reel are described below.

In some embodiments, digital elements can be projected onto the display surface to add animations to existing mechanical slot games. In some examples, payline indicators can appear on the mechanical reels as an overlay to better indicate the paylines being played by a user.

In additional or alternative embodiments, digital elements can be projected onto the display surface to add bonus features that play out on the mechanical reels. In some examples, a wagering game on an EGM with a mechanical reel can include a bonus feature in which mini virtual reels appear as overlaid on the mechanical reels. When three mini virtual reels appear, each one is triggered, and the mini reals play out for possible wins. In additional or alternative examples, bonus mini virtual reels that are part of a line win can spin on the virtual reels and form wins. In additional or alternative examples, a wagering game on an EGM with a mechanical reel can include a virtual multiplier symbol that may appear on any of the paylines associated with the mechanical reel and result in a bonus multiplier applied to any winning combinations on the payline. In additional or alternative examples, a wagering game on an EGM with a mechanical reel can include displaying virtual feature information onto the mechanical reels to give player's help on how the bonus feature works. In additional or alternative examples, a wagering game on an EGM with a mechanical reel can include a digital element that is virtually overlaid over a winning combination (e.g., text indicating a cash value of a win).

In additional or alternative embodiments, progressive pots can be a part of the virtual reel symbols, which can be updated in real time and displayed onto the mechanical reels.

In additional or alternative embodiments, the mechanical reels can include an entirely “blank” symbol that can be overlaid by a digital element to provide dynamic content. In some examples, the blank symbols can be overlaid by a virtual wild symbol with varying multipliers. In additional or alternative examples, the virtual symbol overlaid on the blank symbol can be randomized after the mechanical reels stop.

In additional or alternative embodiments, the mechanical reels can have a partly blank symbol (e.g., blank space around the physical symbol) that is overlaid with dynamic content. In some examples, the blank space associated with the partially blank symbol can be overlaid with an indication of an amount won in response to the corresponding symbol being part of a winning combination of symbols. In additional or alternative examples, the blank space associated with a partially blank symbol can be overlaid with information associated with an incrementing jackpot associated with the corresponding symbol.

In additional or alternative embodiments, the digital element can be used to display dynamic content such as revealing game functionality or rules associated with a mystery symbol. In some examples, the dynamic content can be provided in response to user input such as touch input. For example, the result of a spin of a set of mechanical reels may include four mystery jackpot symbols that prompt the user for user input. In response to the user input (e.g., touch) the mystery jackpot symbols can reveal hidden results.

In additional or alternative embodiments, the digital element can be used to add functionality to physical symbols on the mechanical reels. In some examples, the digital element includes multipliers, collect items, or card suits—to enable in-game eligibilities, change odds, or apply cosmetic changes to the game.

In additional or alternative embodiments, the digital element can be used to change a color of the entire screen to indicate special phases of the game. For example, in response to a hot-phase, jackpot trigger scenario, or tension scenario, the EGM can apply a semi-transparent color to the entire reflective image to color the mechanical reels visible through the display surface.

In additional or alternative embodiments, the digital element can introduce game functionality such as “sticky” content to spinning mechanical reel games. In some examples, while the reels spin, “sticky” symbols can be presented through the projector already at the position they will be persisting on. So, it is possible to, even while the reels spin, project a symbol on a static position. In additional or alternative examples, this can enable “Spin & Hold”-like features. In additional or alternative examples, a frame of a mechanical reel can be highlighted by the projector while a tension spin is happening. In additional or alternative examples, the projector can add animations to the tension spin/the reel's frame.

In additional or alternative embodiments, the digital element can be used to provide a “Hold wild symbols” feature. Traditionally, games withholding wilds or jumping wilds are not possible with mechanical reels. Projecting the digital element onto the display surface can allow virtual symbols to “overrule” the physical symbol on the underlying mechanical reel.

In additional or alternative embodiments, the digital element can enable binding features. In some examples, a user can win in response to a symbol appearing a threshold number of times. The digital element can include a counter overlaid on the symbol indicating a number of times the symbol has been displayed.

In additional or alternative embodiments, the digital element can enable “Fake” Wild features. In some examples, the digital element can include a virtual mystery symbol that is only revealed after an animation occurs.

In additional or alternative embodiments, projecting the digital element can include variable projection intensity depending on in-game events. In some examples, the digital element can enable “Charging” symbol in which a symbol's brightness increases over time, the more often they appear. Once a threshold is reached, the symbol is displayed with max. brightness and might “explode” in a win presentation. In additional or alternative examples, the digital element includes a virtual overlay of some of the mechanical symbols as long as the player is not eligible to use the physical symbols. The overlay's intensity increases over time or is removed entirely once the physical symbol is eligible to be used.

In additional or alternative embodiments, the digital element can enable dynamic spotlight projection. In some examples, whenever a payout-relevant symbol moves across the correct position on the spinning reel the projector is activated for the very short time frame where the symbol is on the correct position. The projection is used to highlight the importance of the specific symbol on the specific reel position. In additional or alternative examples, projection duration is synced to the reel spin speed: if the reels spin fast the projection is only very short, but if the reels spin rather slow the projection is longer (as long as the symbol touches the correct position).

In additional or alternative embodiments, the digital element can enable a strobe effect. In some examples, a strobe effect can be created by the projector to have a special symbol persist in 1 spot as the reel spins or can move slower or in a reverse direction to the reel spin or migrate from 1 reel to another in either direction.

In additional or alternative embodiments, the projector and display surface can be used to eliminate all permanent symbols. In some examples, rather than fixed reel strips, blank reels are used. All symbols can be projected onto the display surface, which can provide the flexibility of video reels with the look and feel of mechanical reels.

In additional or alternative embodiments, the digital element can indicate a progressive bar. In some examples, a transparency line (e.g., a line separating a transparent portion and opaque portion of the display surface) can act as a progressive bar, filling up and losing opacity as a player wins.

In additional or alternative embodiments, the set of mechanical reels can include an entirely empty mechanical reel that only gets active (dynamically projected with content) based on conditions. In some examples, the digital element can be projected onto the empty mechanical reel based on a user selecting to play additional lines. For example, based on how many lines the player bets on, the transparent reel becomes more visible and becomes playable if a bet is placed on it. In additional or alternative examples, the transparent reel can only display additional information about the game, also toggleable based on player preferences. The transparent reel can be the emergency substitute for the mechanical reel. In additional or alternative examples, the digital element can provide a backup if the mechanical reel is turned off (e.g., not operating correctly), but the machine is still useable since the transparent reel is working.

Various embodiments described herein provide technical advantages. In some embodiments, EGMs with mechanical reels can be designed (or retrofitted) that are able to provide more gambling games and game features than traditional mechanical-reel EGMs.

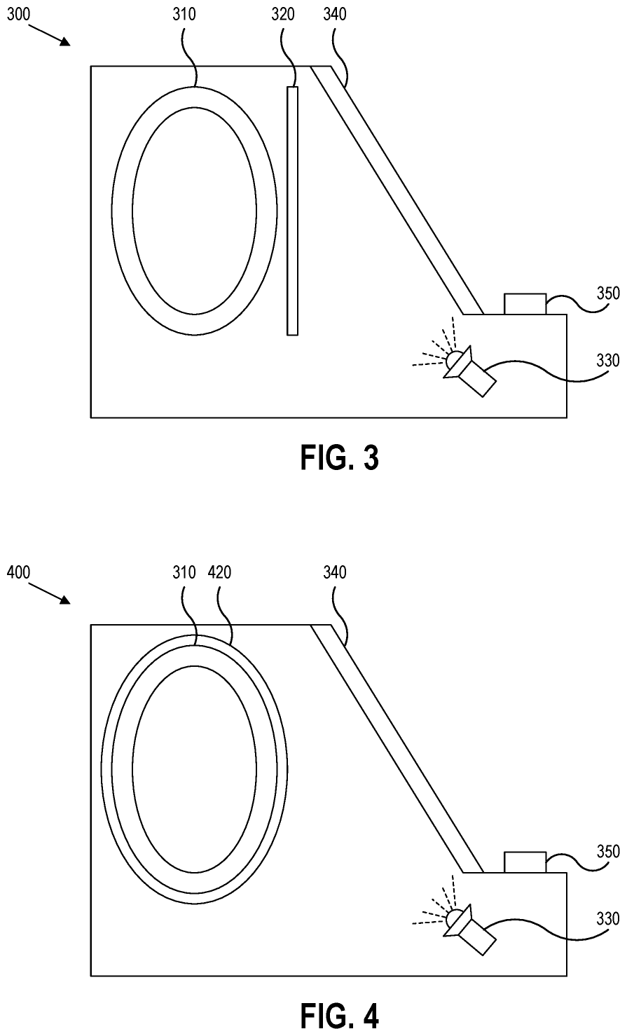

FIGS. 6-8 illustrate examples of operations performed by an EGM (e.g., EGM 300, 400) that includes a mechanical reel (e.g., mechanical reel 310) and a display surface (e.g., display surface 320 or reflective film 420) positioned between the mechanical reel and a projector (e.g., projector 330).

### FIG. 6

At block 610, processing circuit 12 spins a set of mechanical reels as part of a wagering game.

At block 620, processing circuit 12 varies a transparency of a display surface. In some embodiments, the display surface includes a reflective film overlaid on the set of mechanical reels and configured to block visibility of the mechanical reel by a user of the EGM at positions on the display surface receiving light from a projector. In additional or alternative embodiments, the display surface includes a transparent film overlaid on the set of mechanical reels and configured to allow the set of mechanical reels to be viewed through the display surface.

In additional or alternative embodiments, the display surface includes an active component (e.g., a plurality of liquid crystals with variable orientations) that affects the transparency of the display surface. In some examples, the EGM includes a controller configured to apply an electric charge to the display surface and control the orientation of the plurality of liquid crystals.

At block 630, processing circuit 12 determines information to be displayed. In some embodiments, the information to be displayed is based on a physical symbol on a mechanical reel. In additional or alternative embodiments, the information to be displayed is based on an identity of a user playing on the EGM. In some examples, the information includes an adjustment to existing information based on a visual impairment (e.g., color blindness or farsightedness). In additional or alternative embodiments, the information to be displayed is based on an identity of a wagering game being played on the EGM.

At block 640, processing circuit 12 displays, via a projector, a digital element on the display surface. In some embodiments, the display surface is between the projector and the set of mechanical reels. In additional or alternative embodiments, the content of the digital element is based on the information to be displayed. In some examples, the digital element comprises a virtual version of content on the set of mechanical reels. The virtual version can include a different color, size, or theme of physical symbols or text on the mechanical reels. The virtual version can include an animated or emphasized version of the content on the set of mechanical reels.

In additional or alternative embodiments, the projector includes a laser projector configured to project the digital element on a portion of the display surface blocking a corresponding portion of the set of mechanical reels from being viewed through the display surface.

In additional or alternative embodiments, the EGM includes a sensor configured to detect a position on the display surface on which light from the projector is being displayed relative to a position on the set of mechanical reels. In some examples, processing circuit 12 calibrates the projector's projection of the digital element based on the position on the display surface on which light from the projector is being displayed relative to the position on the set of mechanical reels.

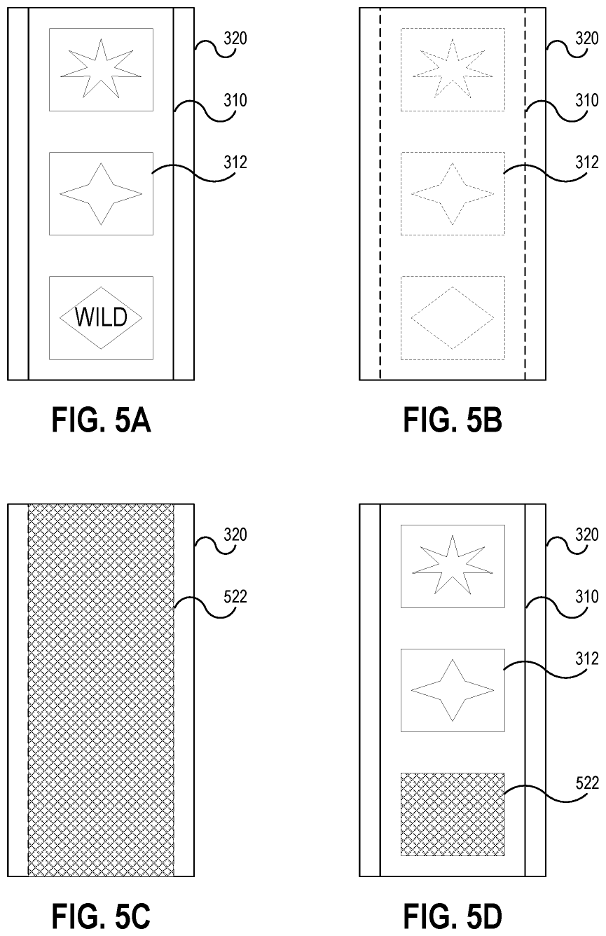

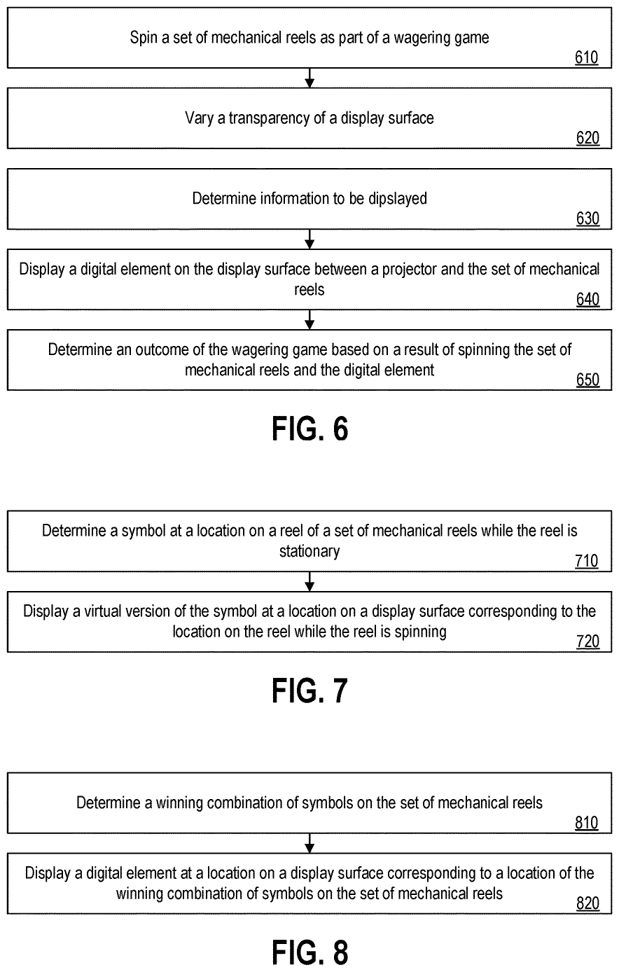

FIGS. 7-8 illustrate examples of operations performed by an EGM to display digital elements as part of operation of a wagering game that uses mechanical reels.

In FIG. 7, at block 710, processing circuit 12 determines a symbol at a location on a reel of a set of mechanical reels while the reel is stationary. At block 720, processing circuit 12 displays a virtual version of the symbol at a location on a display surface corresponding to the location on the reel while the reel is spinning.

In FIG. 8, at block 810, processing circuit 12 determines a winning combination of symbols on the set of mechanical reels. At block 820, processing circuit 12 displays a digital element at a location on a display surface corresponding to a location of the winning combination of symbols on the set of mechanical reels.

In additional or alternative embodiments, the projector can project the digital elements to add features available in virtual-reel games to the mechanical reel-game. In some examples, the digital element may include an entire bonus game triggered in response to a symbol combination. In additional or alternative embodiments, the projector can project the digital elements to provide new features that require the presence of mechanical reel and a digital element. In some examples, the digital element may include a counter overlaid on a physical jackpot symbol showing a real-time jackpot total across multiple slot machines. In additional or alternative examples, the wagering game may use the ability to adjust the transparency of the digital surface as a game element such as changing the transparency of different portions of the display surface (and revealing different portions of the mechanical reels) in response to different game triggers.

Returning to FIG. 6, at block 650, processing circuit 12 determines an outcome of the wagering game based on a result of the spinning the set of mechanical reels and the digital element. In some embodiments, the grid of symbols used to determine an outcome of the wagering game can be formed by a combination of physical symbols and virtual symbols. In additional or alternative embodiments, displaying the digital element includes displaying the digital element at a location on the display surface corresponding to a location of the winning combination of symbols on the set of mechanical reels.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks. The flowchart and block diagrams in the FIGS. illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. An electronic gaming machine (“EGM”) comprising:
a set of mechanical reels;
a display surface; and
a projector configured to project a digital element on the display surface, the display surface being located between the projector and the set of mechanical reels.

2. The EGM of claim 1, wherein the projector is further configured to project the digital element onto the display surface, and
wherein the display surface comprises a reflective film overlaid on the set of mechanical reels and configured to block visibility of the mechanical reel by a user of the EGM at positions on the display surface receiving light from the projector.

3. The EGM of claim 1, wherein the display surface comprises a transparent film overlaid on the set of mechanical reels and configured to allow the set of mechanical reels to be viewed through the display surface.

4. The EGM of claim 1, wherein the projector comprises a laser projector configured to project the digital element on a portion of the display surface blocking a corresponding portion of the set of mechanical reels from being viewed through the display surface.

5. The EGM of claim 1, wherein the set of mechanical reels comprises a mechanical reel with a blank portion, and
wherein the projector is further configured to project the digital element on the display surface to cause the digital element to appear to a user of the EGM as though it is located on the blank portion.

6. The EGM of claim 1, wherein the mechanical reel comprises a physical symbol that comprises a blank space,
wherein the projector is further configured to project the digital element on the display surface to cause the digital element to appear to a user of the EGM as though it is located on the blank space, and
wherein the digital element comprises an indication of additional information associated with the symbol.

7. The EGM of claim 1, further comprising:
processing circuitry communicatively coupled to the projector;
memory communicatively coupled to the processing circuitry and comprising instructions stored therein that are executable by the processing circuitry to cause the EGM to perform operations comprising:
determining a symbol at a location on a reel of the set of mechanical reels while the reel is stationary; and
displaying, using the projector, a virtual version of the symbol at a location on the display surface corresponding to the location on the reel while the reel is spinning.

8. The EGM of claim 1, further comprising:
processing circuitry communicatively coupled to the projector;
memory communicatively coupled to the processing circuitry and comprising instructions stored therein that are executable by the processing circuitry to cause the EGM to perform operations comprising:
determining a winning combination of symbols on the set of mechanical reels; and
displaying, using the projector, the digital element at a location on the display surface corresponding to a location of the winning combination of symbols on the set of mechanical reels.

9. The EGM of claim 1, wherein the digital element comprise a virtual version of content on the set of mechanical reels.

10. A method of operating an electronic gaming machine (“EGM”), the method comprising:
spinning a set of mechanical reels as part of a wagering game; and
displaying, using a projector, a digital element on a display surface between the projector and the set of mechanical reels.

11. The method of claim 10, wherein the display surface comprises a reflective film overlaid on the set of mechanical reels that is transparent, and
wherein displaying the digital element comprises blocking a portion of the set of mechanical reels from being visible through the display surface.

12. The method of claim 10, wherein the display surface comprises a plurality of liquid crystals, the method further comprising:
applying an electric charge to the display surface to control an orientation of the plurality of liquid crystals to vary a transparency of the display surface.

13. The method of claim 10, further comprising:
determining a symbol at a location on a reel of the set of mechanical reels while the reel is stationary,
wherein displaying the digital element comprises displaying a virtual version of the symbol at a location on the display surface corresponding to the location on the reel for a number of spins of the reel.

14. The method of claim 10, further comprising:
determining a winning combination of symbols on the set of mechanical reels,
wherein displaying the digital element comprises displaying the digital element at a location on the display surface corresponding to a location of the winning combination of symbols on the set of mechanical reels.

15. The method of claim 10, further comprising:
determining content on the set of mechanical reels,
wherein displaying the digital element comprises displaying a virtual version of the content at a position on the display surface corresponding to a location of the content on the set of mechanical reels.

16. The method of claim 15, further comprising:
determining a configuration associated with a user,
wherein displaying the virtual version of the content comprises determining the virtual version of the content based on the configuration associated with the user, and
wherein the configuration comprises a configuration associated with a visual impairment.

17. The method of claim 10, wherein displaying the digital element on the display surface between the projector and the set of mechanical reels comprises displaying the digital element on the display surface with an intensity based on a metric associated with play of the wagering game.

18. The method of claim 10, further comprising:
determining an outcome of the wagering game based on a result of spinning the set of mechanical reels and the digital element.

19. An electronic gaming machine (“EGM”) comprising:
processing circuitry; and
memory communicatively coupled to the processing circuitry and comprising instructions stored therein that are executable by the processing circuitry to cause the EGM to perform operations comprising:
determining physical content on a set of mechanical reels associated with a wagering game; and
displaying, using a projector, digital content on a display surface between the projector and the set of mechanical reels, the digital content based on the physical content.

20. The EGM of claim 19, wherein the display surface comprises a reflective film overlaid on the set of mechanical reels,
wherein the reflective film comprises a plurality of liquid crystals that determine a transparency of the display surface based on their orientation,
the operations further comprising:
adjusting a number of mechanical reels of the set of mechanical reels that are visible by a user of the EGM by applying an electric charge to the display surface.
